(19) United States
(12) Patent Application Publication
(10) Pub. No.: US 2014/0372970 A1
(43) Pub. Date: Dec. 18, 2014

(54) METHOD TO AUTO GENERATE JAX-RS REST SERVICE IMPLEMENTATION CLASSES FROM EXISTING INTERFACES

(71) Applicant: International Business Machines Corporation, Armonk, NY (US)

(72) Inventors: Scott J. Broussard, Cedar Park, TX (US); Swagat Chakravarty, Brussels (BE); Amartey S. Pearson, Austin, TX (US)

(21) Appl. No.: 13/917,399

(22) Filed: Jun. 13, 2013

(51) Int. Cl. G06F 9/44

(52) U.S. Cl. CPC G06F 8/30
USPC 717/106

(57) ABSTRACT

A method, computer program product, and system for auto generating a Java application programming interface (JAX-RS) for representational state transfer (REST) web services. A reference interface for a REST service object is received by a server computer system. A set of determiners defines a plurality of configuration values for a REST service object to generate a service binding. A plurality of resource methods for each resource class in the reference interface is determined, and for each resource method, a parameter, a return type, and an exception are determined. Each resource method of each class is sequentially processed and the name of each resource is written into a string buffer. The operation type for each resource method for each resource class is determined based on at least one predefined match and an operation name is written into the string buffer for each resource method. A return type is determined for each resource method for each resource class. Each parameter in the resource method is converted to a JAX-RS compatible parameter.

### BACKGROUND

Embodiments of the invention generally relate to web services provided by the World Wide Web (WWW) and, more particularly, to generating interfaces that are compliant with the Representational State Transfer (REST) software architecture.

REST has gained widespread acceptance across the Web as a simpler alternative to Simple Object Access Protocol (SOAP) and Web Services Description Language (WSDL) based web services. REST defines a set of architectural principles that enable a developer to design web services that focus on a system's resources.

The REST architectural style was developed by the W3C Technical Architecture Group in parallel with development of the Hypertext Transfer Protocol (HTTP) specification version 1.1. The W3C defines a web service as a software system designed to support interoperable machine-to-machine interaction over a network. The REST architectural style constrains a software architecture to a client/server architecture designed to use a stateless communications protocol such as HTTP. In this architectural style, clients and servers exchange representations of resources by using a standard interface and protocol. The REST server generates responses that include links to other resources to allow applications to navigate between related resources. This type of response embeds links. The RESTful web service exposes a set of resources identified by Uniform Resource Identifiers (URIs) which provide a global addressing space for resource and service discovery. Resources are manipulated by a fixed set of operations: create (PUT), read (GET), update (POST), and delete (DELETE).

JAX-RS is a Java programming language application program interface (API) to facilitate development of applications that use the REST architecture. JAX-RS defines server-binding specifications but leaves it to the implementation framework to define client bindings and APIs. The JAX-RS API defines Java programming language annotations for development of RESTful web services. These annotations include, but are not limited to, @Path, @GET, @POST, @PUT, @DELETE, @PathParam, @QueryParam, @Consumes, @Produces, @Provider, and @Context.

A resource class annotated with @Path is a root resource class and provides access to sub-resources. The @Path annotation identifies the URI path template to which the resource responds and is specified at the class or method level of a resource. URI path templates are URIs with variables embedded within the URI syntax, with variables denoted by braces. The variables are substituted at runtime for a resource to respond to the request based on the substituted URI.

Request method designators are runtime annotations annotated with an @HTTP Method. A set of request method designators defined by JAX-RS includes @GET, @POST, @PUT, and @DELETE. Multiple parameters may be extracted from the URI by using the @PathParam or @QueryParam annotations. The @Consumes annotation is used to specify the Internet media types (MIME) of representations that a resource can accept or consume from the client. The @Produces annotation is used to specify the MIME media types of representations that a resource can produce and send back to the client. A resource class can respond to and produce all MIME media types of representations specified in the HTTP request and response headers. Common well-known MIME types used by REST services include JavaScript Object Notation (JSON), Extensible Markup Language (XML), and Extensible HyperText markup Language (XHTML). In general, RESTful web services can return data in one of several standard formats such as XML, Comma Separated Values (CSV), Really Simple Syndication (RSS), Atom, and JSON. JSON is a simple text-based format for data exchange derived from JavaScript.

### BRIEF SUMMARY

In one embodiment, a method is provided for migrating existing interfaces (local/remote/web services) to REST servers by using minimum or no input enabling quick conversion of a legacy application into to a REST application.

In one embodiment, a method is provided for auto generating a Java application programming interface (JAX-RS) for representational state transfer (REST) web services. The method includes automatically generating a JAX-RS framework with a first set of interfaces for a server application from a non-REST description; providing a migration path from the first set of interfaces to a REST uniform resource identifier (URI) pattern; and providing a user interface for assisting a user in developing the JAX-RS framework.

In another embodiment, a method is provided for building a new REST application, based on very simple Java programming interfaces. The interfaces can then be discarded since the generated REST code is no longer interface-based.

In one embodiment, a method is provided for auto generating a Java interface (JAX-RS) for representational state transfer (REST) web services. A reference interface for a REST service object is received by a server computer system. A set of determiners defines a plurality of configuration values for a REST service object to generate a service binding. A plurality of resource methods for each resource class in the reference interface is determined, and for each resource method, a parameter, a return type, and an exception are determined. Each resource method of each class is sequentially processed and the name of each resource is written into a string buffer. The operation type for each resource method for each resource class is determined based on at least one predefined match and an operation name is written into the string buffer for each resource method. A return type is determined for each resource method for each resource class. Each parameter in the resource method is converted to a JAX-RS compatible parameter.

In other embodiments, a REST server can be generated using any existing technology (e.g., wink, abdera, jersey), and any format (e.g., feed/non-feed) with minimum input from the developer/user.

### BRIEF DESCRIPTION OF THE DRAWINGS

These and other advantages and aspects of the embodiments of the disclosure will become apparent and more readily appreciated from the following detailed description of the embodiments taken in conjunction with the accompanying drawings, as follows.

FIG. 1 illustrates several prior art remote interfaces.

FIG. 2 illustrates a REST service object in accordance with an exemplary embodiment.

FIG. 3 illustrates REST reference interface code and descriptions of determiners identified in FIG. 2 that supplement the information in the reference interface to generate a JAX-RS service binding in accordance with an exemplary embodiment.

FIG. 4 illustrates the service code generated and the URI mapping and the XML response that is produced back to the client when the URL is called in an exemplary embodiment.

FIG. 5A illustrates a direct conversion of an interface to a REST service with no inputs in an exemplary embodiment.

FIG. 5B illustrates generation of an interface to a REST service with a custom input in an exemplary embodiment.

FIG. 6 illustrates exemplary REST URIs that show the relationships to the methods of the interface shown in FIG. 5B.

FIG. 7 illustrates a customized auto generation configuration object in which the inputs are customized to control the generation results.

FIGS. 8A-8B illustrates processing logic for building a new REST application based on very simple Java programming interfaces in an exemplary embodiment.

FIG. 9 illustrates a schematic of an exemplary computer system/server for implementation of the REST server.

### DETAILED DESCRIPTION

The following description is provided as an enabling teaching of embodiments of the invention including the best, currently known embodiment. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of the invention and not in limitation thereof, since the scope of the invention is defined by the claims.

Many software developers today are migrating existing applications to REST-based services or are writing new RESTful applications. For migration of legacy applications, instead of re-writing all existing servlet or web service code to the REST-based service, the embodiments disclose an auto-generation tool that may generate some of the code for the application. The disclosed embodiments are applicable to applications that have existing web service interfaces. New applications, which do not have existing interfaces, can use the methods disclosed to generate code by writing simple reference interfaces. In short, the embodiments create a pathway for REST development.

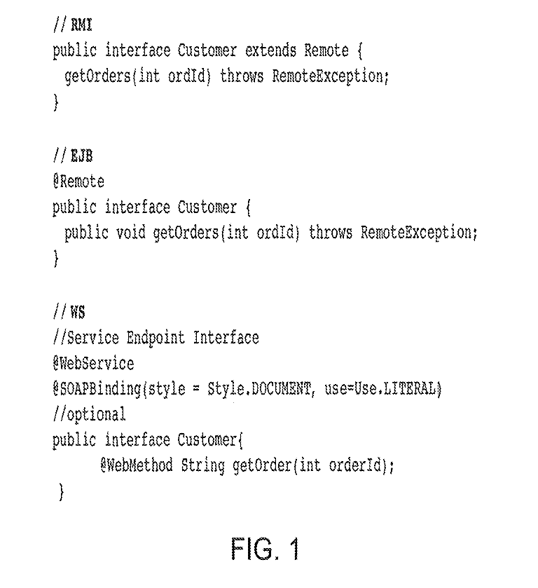

Some of the first considerations for a developer when interfacing an application with an existing product are the interfaces/methods and data. The developer (also referred to herein as the user) has to consider web services, or Remote Method Invocation (RMI) interfaces, which are essentially interface/methods and data that would be exchanged. A remote interface is an interface that extends the java.rmi.Remote interface and declares a set of methods that may be invoked from a remote Java Virtual Machine (JVM). The Java RMI is an API that performs the object-oriented equivalent of remote procedure calls (RPC). Examples of remote interfaces are illustrated in FIG. 1 and include RMI, Enterprise JavaBeans (EJB), and Web Service (WS).

The disclosed embodiments serve the purpose of having the developer consider REST, not only by auto-generating code that may be used, but also by creating a path to follow for REST development. The disclosed embodiments generate JAX-RS service methods and classes that include, but are not limited to, the following features:

(1) provides a JAX-RS implementation of the user's interface method with minimal REST-related input;

(2) adds documentation and helper code to guide the user on integrating persistence into the REST application;

(3) guides the user on interfacing a legacy application from REST implementation classes;

(4) provides universally unique identifier (UUID) supporting classes for the developer to use in his REST application;

(5) guides the developer on how existing models would be used in the REST application;

(6) guides the developer on handling exceptions;

(7) enables the developer to handle response types of atom feeds, jaxb, or plain response building; handles all content types; and

(8) enables the user to add operation types, handle content types, handle exceptions, handle UUIDs, persist data, and call the reference API. One embodiment requires the addition of one line per method as input with the method body generated automatically.

In one embodiment, the method uses reflection to scan existing interfaces and methods, parameters, exceptions thrown, and return types for each method. These existing interfaces are called reference interfaces. The reference interfaces can be pre-existing in case there is a legacy application which the developer would like to “REST-ify.” For a new application, the developer still needs to create skeleton reference interfaces,

A resource method is a method of a resource class that is annotated with a request method designator to handle requests on a corresponding resource. A sub-resource method is a method of a resource class that is used to handle requests on a sub-resource of the corresponding resource. For the purpose of illustrating the inventive concepts, the resource and sub-resource methods identified in the table below will be referred to in the exemplary embodiments.

```
TABLE
interface Order{
  Order getOrder(String orderId) throws RemoteException
  Order getOrder(String contactID, String billingFirstName, String
billingLastName) throws RemoteException, InvalidParamException;
  Order updateOrder(String orderId,String contactID, String
orderDate, int orderType, String billingFirstName) throws
RemoteException, InvalidParamException;
  Order createOrder(String contactID, String orderDate, int orderType,
String billingFirstName) throws RemoteException,
InvalidParamException
  void deleteOrder(String contactID, String orderDate, int
orderType, String billingFirstName) throws RemoteException,
InvalidParamException
}
```

Each class could be scanned from the first method to the last method by using Class.getDeclaredMethods(..). When a resource method is invoked, parameters annotated with the @PathParam, @QueryParam, and @Context annotations are mapped from the request based on the semantics of the annotation. A Java source class would be generated on a storage device as each method is iterated. A class is the fundamental unit of program structure in Java. This generated Java source class would be the REST resource class (also called the REST service class). A resource class is a Java class that uses JAX-RS annotations to implement a corresponding web resource.

Consider the following simple interface in an exemplary embodiment, which will be referred to herein as the reference interface:

package com.ibm.rest.example.interfaces;
public interface Order {

public Order getOrder(String orderId) throws OrderException;

}

In order for the developer to use the JAX-RS interface tool, the following call is made:

Object[ ][ ] autogenParams = null;
autoGen.generateJavaSource(“order”, “OrderResource”, //
“com.ibm.example.resources”, Order.class,autogenParams);

The JAX-RS interface tool produces the following code:

```
@Path(“/order”)
public class OrderResource
{
  private @Context UriInfo uriInfo;
  public OrderResource( ) {
}
public OrderResource(UriInfo uriInfo) {
  this.uriInfo = uriInfo;
}
@GET
@Path(“/{uuid}/}getOrder”)
@Produces(MediaType.APPLICATION_ATOM_XML)
@Consumes(MediaType.APPLICATION_ATOM_XML)
public javax.ws.rs.core.Response getOrder
(@QueryParam java.lang.String arg0) {
  //Persistence - each method would have its own
  //Or not have any at all
  Identifier identifier = new MyAppUri(uriInfo).getId( );
  try {
    String target_sigs[ ] = {“java.lang.String”};
    Object target_parms[ ] = {arg0};
    //Optionally invoke the reference API...
    //But that's only in case reference API's are...
    //not just for ref. but needed to be invoked as well...
    //Invoke existing API now...
    Object OrderObject = invoke(“getOrder”, target_params, target_sigs);
    return Response.ok( ).entity(OrderObject).build( );
  } catch (com.ibm.rest.example.model.OrderException e0) {
    Response.serverError( ).build( );
  }
}
private Object invoke (String operation, Object parms[ ],
String signatureTypes[ ])
      throws Exception
{
    //This would call myAPIClient.methodName(param0,param1..) );
    ((Object)myAPIClient).invoke(operation, parms, signatureTypes);
}
```

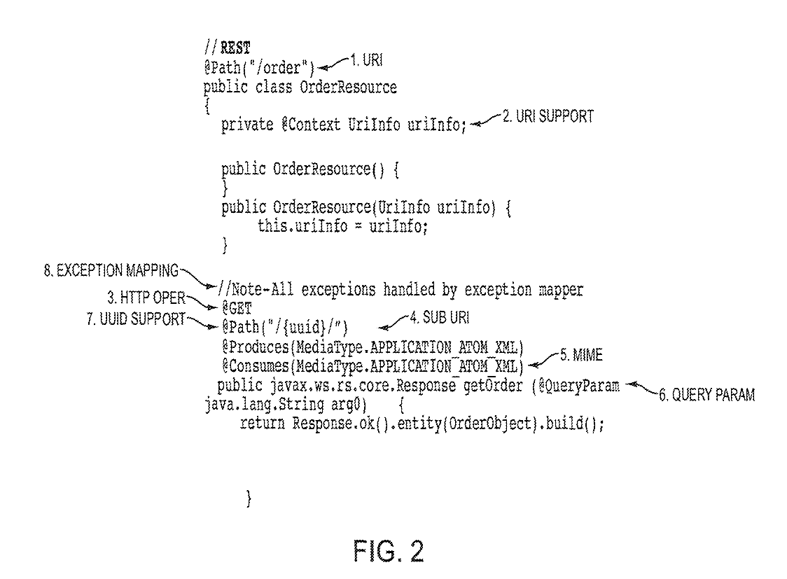

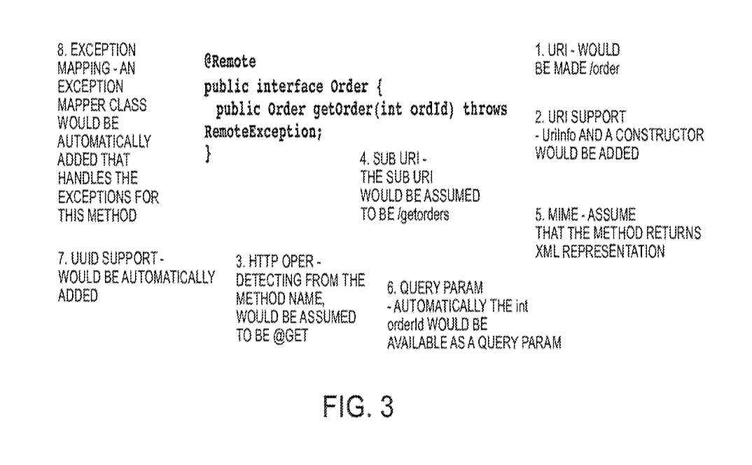

FIG. 2 illustrates a REST service object in an exemplary embodiment corresponding to the preceding code. The arrows in the figure identify a plurality of determiners (configuration information) that are further described in FIG. 3. The determiners included in FIG. 2 are: (1) URI, (2) URI support, (3) HTTP operation, (4) Sub-URI, (5) MIME, (6) Query Parameters, (7) UUID support, and (8) exception mapping. FIG. 3 illustrates REST reference interface code and descriptions of the determiners identified in FIG. 2 that supplement the information in the reference interface to generate a JAX-RS service binding in an exemplary embodiment.

With further reference to FIGS. 2-3, the URI determiner would be /order. The HTTP operation detected from the method name would be assumed to be @GET. The URI support determiner would be guessed to be /getorders. Regarding MIME, the user would assume that the method returns an XML representation. Based on the REST reference interface code, int ordid would automatically be available as a query parameter. UUID support would be added automatically. An exception mapper that handles exceptions for this method would be added automatically.

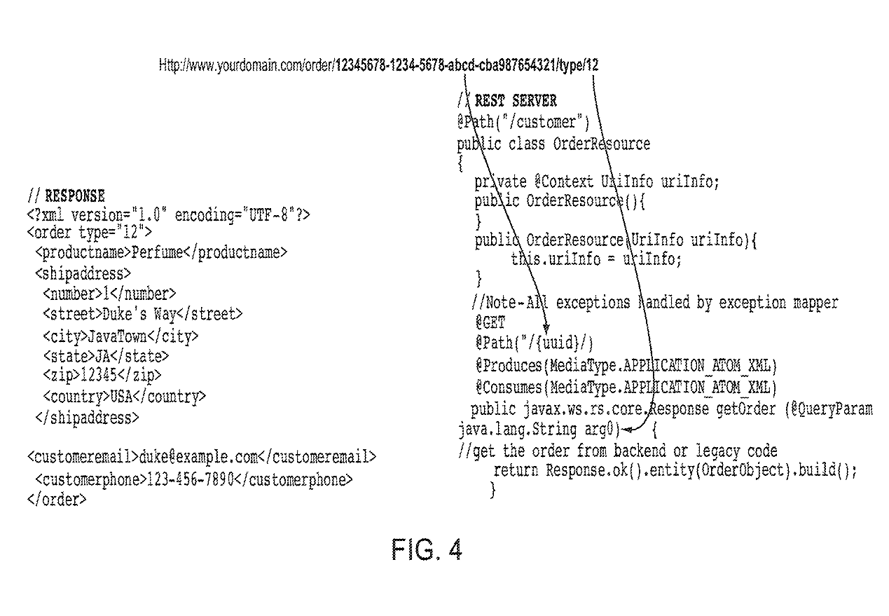

FIG. 4 illustrates the service code generated and the URI mapping and the XML response that is produced back to the client when the URL is called in an exemplary embodiment. The service code generated for the REST server is shown on the right side of the figure. The @Context annotation is used to inject an instance of a supported resource. It can be used to inject an instance of UriInfo into a class field or method parameter.

The left side of FIG. 4 shows the XML response that is produced back to the client when the URL at the top of FIG. 4 is called. More specifically, the client application calls the URI which executes the generated service code to call an implementation object that conforms to the reference implementation, and then returns the response in XML to the client.

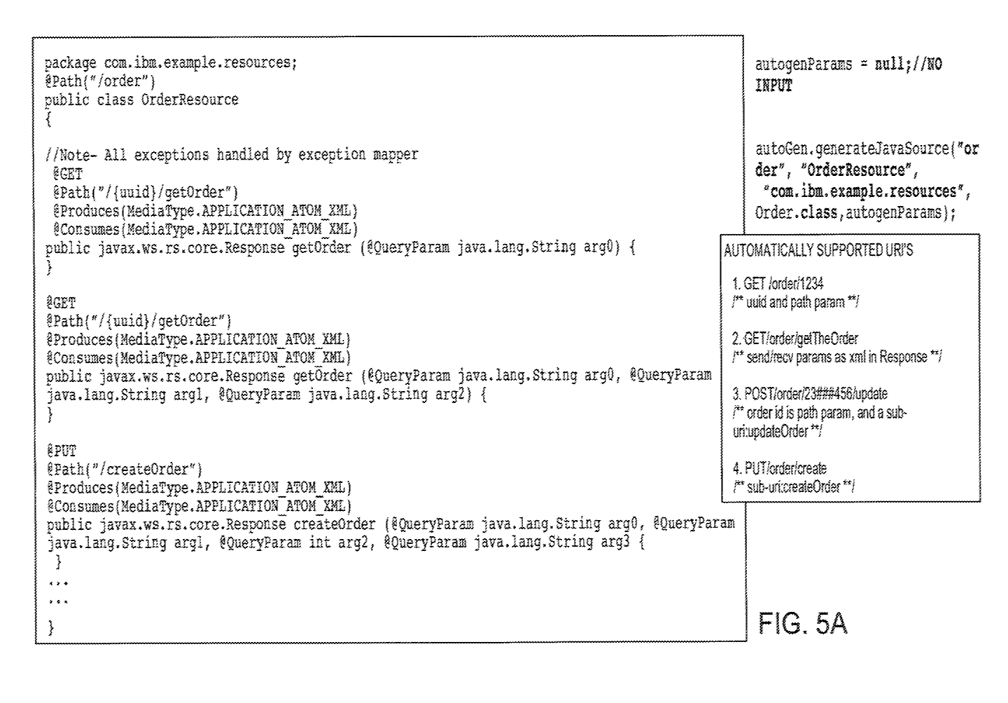

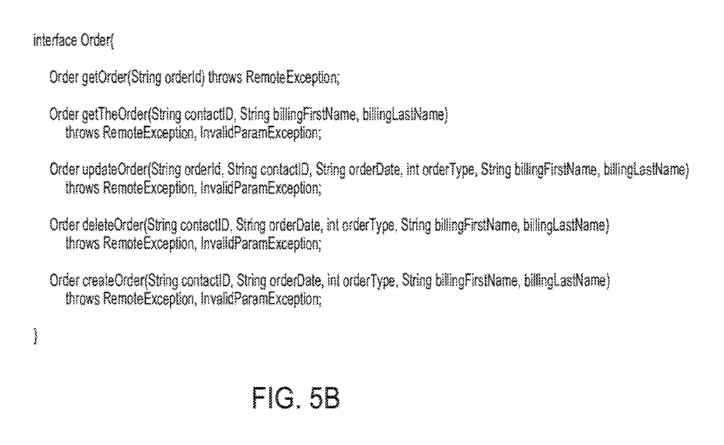

FIG. 5A illustrates an exemplary JAX-RS service implementation stub that would be generated using the auto generation tool. On the left of the figure, the JAX-RS generated implementation is shown. The upper right side of the figure shows the generation tool configuration that was used. In this example, all defaults for the tool are taken. The tool has generated the method implementations (without business logic in the body of the methods, that would be provided additionally by the developer to mate the REST JAX-RS remote communication layer to the internals of the target application). The reference interface OrderResource is used to generate the REST JAX-RS stub with the appropriate annotations such as @GET and @Path so that it is recognized by the JAX-RS runtime. The other annotations are used to provide additional metadata to the JAX-RS runtime so that it knows how to match up the incoming REST URI requests with particular service methods.

The lower right side of FIG. 5A provides some examples of the REST URIs that could be used against the application. For example, the GET/order/1234 retrieves a specific Order Response. POST will update an existing order with the XML document in the body of the request, and PUT will create a new order with the XML document in the body of the request.

FIG. 5B illustrates generation of an interface to a REST server with a custom input in an exemplary embodiment. The figure shows the reference interface that corresponds to the generated interface in FIG. 5A.

There are various URI formats to achieve the same thing, and that are equivalently mapped to the internal JAX-RS service implementation. For example, /order/1234 specifies the order with ID 1234, or alternatively /order/getOrder/?id=1234 to specify order 1234 could be used. Both are supported REST URI formats.

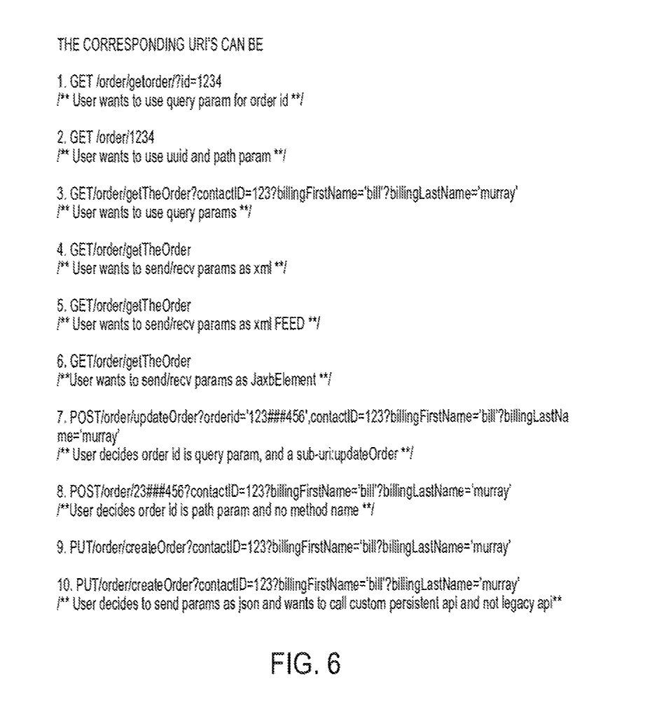

FIG. 6 illustrates exemplary REST URIs that correspond to the methods of the interface shown in FIG. 5B. GET /order/getorder/?id=1234 and GET /order/1234 are alternate syntactical options that are routed to the implementation of the getOrder(String orderid) method. The following provides additional examples:

GET/order/getorder/?contactID=123?billingFirstName=firstname?billingLastName=lastname matches with the interface method Order getOrder(String contactID, String firstName, String lastName).

POST/order/updateOrder/?orderID=1234 ?contactID=123 ?billingLastName=newname?billingFirstName=newname matches with the updateOrder method provided in the interface. It should be noted that the matching actually occurs between the URI and the generated code with the @ annotations.

In order to customize the JAX-RS method, the developer/user can do so by adding one line of code for one line of the method that is to be customized. Each line can have columns identifying the following: (1) Method, (2) RET Type, (3) OP Type, (4) Produces, (5) Consumes, (6) ID_Support, (7) Custom_ID, (8) Persist, and (9) Name_Override. Method is the name of the interface method. RET Type overrides the return type. Return types may include feed, a jaxbelement, a response object, etc. A feed is an XML document that contains a list of items such as customers or orders. A jaxbelement is a Java Architecture for XML Binding (JAXB) representation about an XML element. When XML element information cannot be inferred by the derived Java representation of the XML content, a jaxbelement object is provided. OP Type overrides GET, PUT, POST, and DELETE behavior. Produces overrides content production behavior. Consumes overrides content consumption behavior. ID_Support indicates control, wanting to have a QUID in the URI. Custom_ID indicates the custom QUID name, if any. Persist controls the type of code the developer wants the legacy interface to be called (clsInterface) or to use persistence. Name_Override enables the user to change the name of the method.

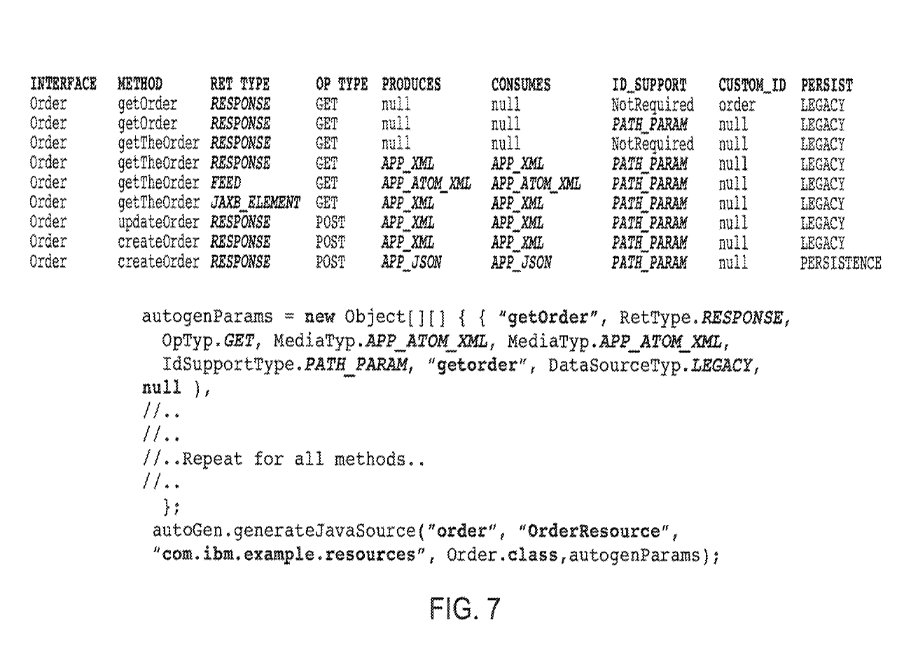

FIG. 7 illustrates a customized auto generation object in which the inputs are customized to control the results. The top half of the figure shows columns identifying the Interface (Order), the Method (e.g., getOrder, updateOrder, createOrder), the RET Type (e.g., response, feed, jaxbelement), the OP Type (e.g., GET, POST), Produces (e.g., null, App_XML, APP_ATOM_XML, APP_JSON), Consumes, ID_Support (e.g., PATH_PARAM), Custom_ID (order, null), and Persistence (e.g., legacy or persistence). The lower half of FIG. 7 shows an example of a customized auto generation response object.

The following line of code generates a JAX-RS subresource method, which returns a feed instead of a response object, then adds classes and methods that help in feed generation, and also adds supporting documentation.

```
autogenParams = new Object[ ][ ] {
{ “getOrderFeed”, RetType.FEED, OpTyp.GET,
MediaTyp.APP_ATOM_XML_IN_FEED, null,
IdSupportType.URI_INFO,
“orderId”, DataSourceTyp.LEGACY, “getOrderFeed” },
};
public org.apache.abdera.model.Feed getOrder (@QueryParam
    java.lang.String arg0)
{
  Object OrderObject = invoke(“getOrder”, target_params,
    target_sigs);
  Feed feedToReturn = createFeed_For_getOrder_OfType_Order
      (OrderObject,OrderObject.getClass( ));
}
private Feed createFeed_For_getOrder_OfType_Order (Object obj,Class
    cls,Sting name)
{
    FeedGenerator gf = CustomFeedGenerator.getInstance( );
}
```

### Autogen Explanation

The generateJavaSource method is provided as an example API in the generation tool. The resourcePath parameter defines the path where the JAX-RS service should be generated. The className provides the name of the JAX-RS service. The packageName defines the package under the resourcePath where the className exists. The Class clsInterface object defines the reference implementation which has been loaded in the class path of the generation program. The autogenParams[ ][ ] is an array of parameters to control and customize the generation process. This could be also provided in a command line form just as easily. If an error occurs, the exception is returned. To throw an exception is to signal an exceptional condition. When the Java interpreter throws an exception, normal program execution stops and the Java interpreter looks for an exception handler that can catch or handle the exception.

private void generateJavaSource(String resourcePath, String className,
String packageName, Class clsInterface, Object[ ][ ] autogenParams)
throws IllegalArgumentException {

Initializing the hashmaps that are formed from the autogeneration parameters, the key for each hashmap is the method name in the reference interface.
initAutogenInputs( );

The two dimensional object array may be transposed into several hashmaps, i.e., hashmaps may be made out of each column in the autogenParams parameter. There may be a hashmap for each factor that affects the signature of the method. Each of these hashmaps is keyed by method names and valued by the override to that factor. For example,
HashMap<String, RetType>typeMap=new HashMap( );
   enables the developer to override each method's return type by using values in the return type enum.

The autogenParams parameter which is an array of arrays can be looped through as follows:
processAutogenInputs(autogenParams);

### Auto Generation Process

Once all the configuration data is available to the program, the Java class may now be written. In the example provided herein, the user will use the code generator APIs to build a custom application that generates the target JAX-RS service object. The code below demonstrates the basic elements of the generation application using the generation tool APIs. Alternately, this customized application could be embodied in a more generic program that reads command line options and performs these same steps.
StringBuffer contents=new StringBuffer( );

Next, the package statement can be written. The imports depend on how the method is implemented. If the developer has wink jars in class path, the keystroke ctrl+shift+h in Eclipse would result in all the imports.
writeJavaClassPackageAndImport(contents, packageName);

### Resource Path Support

For the main resource path example @Path(“/server”)
writeJavaClass_InitialClassDetails(contents, resourcePath, className);

Next, for each method in the reference interface, a JAX-RS method is generated depending upon inputs.

Method mMth[ ] = clsInterface.getMethods( );
for (int i = 0; i < mMth.length; i++) {
String name = mMth[i].getName( );

### Default Support

A default method signature should be generated for every method and every factor that the interface exposes. This enables handling of cases for which the developer has provided either no inputs or partial inputs. Reflection is used to iterate over all the methods.

processAutogenDefaults(contents, name);
Class returnType = mMth[i].getReturnType( );
Class sigTypes[ ] = mMth[i].getParameterTypes( );
Class expTypes[ ] = mMth[i].getExceptionTypes( );

### Operation Support

The operation GET/PUT/POST/DELETE can be overridden by the developer manually or through configuration parameters. If the operation has not been overridden, there is a default to guess on the method name as was done in the “Default Support” section.
contents.append(“@”+operation.getOperation( )+“\r\n”);

### Subresource Name and Id Support

The name of the subresource can either be a method of a legacy interface (by default) or the developer may want to override it. The developer may also override the name of the UUID parameter.

contents.append(“ @Path(\“/{uuid}”+
nameOverride.get(name)+ “\”)\r\n”);

For example, if the return type is Order, an OrderType representation of the Order resource should be created. However, if the developer has not specified a return type, response type is assumed to be the return type.

String objectName = returnType.getSimpleName( ).toLowerCase( );
if (objectName.equals(“void”)) {
objectName = “None”;
}

In case the return type is not a basic Java return type, that is, a complex return type, the developer should make sure that the object variable name reflects the type.

AMetaData meta = getMetaData(returnType);
if (!meta.isNonComplex( )) {
idFor = returnType.getSimpleName( );
}

### Return Type Support

The return type could be a response, feed, JAXBElement<CustomType>, or void. The content type produced by this method is denoted by @Produces(..) and could be text, JSON, or XML. The developer can decide but the default is ATOM_XML. Both the content type and return type have to be taken into account. For example, if the return type is a feed, and atom+xml is the given content type, the object returned is embedded inside the content of a feed's entry.

If a response type is expected, the object returned is present as the entity of a response builder.
writeJavaClassReturnTypes(contents, name, idFor);

### Method Name

The name of the method is the same as in the reference interface. This is an internal name that is not exposed over REST, therefore, there is no problem in keeping the same method name.
contents.append(““+name+” (”);

@Consumes(..) is the content type consumed by this method. The content type consumed could be a feed, a JAXBElement<CustomType>, text, JSON or XML based on the developer's preference. The default content type is ATOM_XML. In addition, helper methods are provided that suggest how to extract the parameters from feed.
MediaTyp consumes=mediaTypeConsumesl.get(name);

If the parameter is not a feed, all method parameters of the reference interface would be provided as QueryParams. Every parameter in the interface method should be processed and converted to JAX-RS compatible parameters. Special care needs to be taken for complex return types. If UUID is forced to be the first parameter, the real first parameter of the method should be ignored as the UUID path parameter represents that ID. All simple Java types should be QueryParams. The first parameter is forced to be the path parameter for ID, therefore, the real parameter is ignored as it is bound to be something that represented ID in the reference interfaces. This ensures that the UUID is available in the method as a parameter of the method.
writeJavaClass_Parameters(contents, consumes, name, sigTypes,meta);

### Id and Persistence Support

REST implementations also suggest using UUIDs in URIs that are a unique identifier of the noun. These UUIDs are dependent on implementation. Some applications would auto generate UUIDs for that purpose; some applications would use Java classes (UUID.class); some databases support UUID generation. Generally, 128 bit IDs are used. Some default support is provided and the rest is left to the implementer.
http://en.wikipedia.org/wiki/Universally_unique_identifier

The autogeneration process provides a support class called Identifier that uses the Java UUID class to generate identifiers. The source of data that the API would eventually return is presented as a choice to the developer. If the developer selects DataSourceType.Persistence, then it is assumed that UUIDs would be persisted as well and support is provided accordingly.

Moreover, autogeneration provides two techniques, depending upon the developer's choice, to retrieve the UUID from the URI inside the JAX-RS method. One method presents it as a path parameter; the other method helps to grab the UUID from UriInfo. UriInfo is an injectable object that provides access to application and request URI information in the JAX-RS environment.

Since the developer does not know what the data source behind the REST entities is, e.g., the data source could be a database or a legacy application (such as a web service) for which this application is exposing REST URIs, some skeleton support is provided to the developer to help him decide how to proceed with the design. The UUID could be extracted into a helper class or if persistence support is requested, a skeleton representation may be provided that would help the developer interface the persistence classes.

For cases in which the UUID is also stored in the database, a call to UUIDStore.get(uuid) returns an identifier that has special properties set for the UUID, which may help to identify the type of object that it represents.
writeJavaClass_IdSupportCode(contents, name, idFor, objectName);

The try block, i.e., exception handling mechanism, can be initiated:
contents.append(“try {\r\n”);

Reflection may be used to call the reference APIs that the developer demands to be called from this method. If the reference interfaces need to be invoked and if they form the data source of this method, the following may be used to invoke the reference API:
writeJavaClass_SignaturesRefAPI(sigTypes, contents, name);

If the developer decides that this method would return a feed, support should be added to call a create feed method; the actual method is then added later.
writeJavaClass_FeedGenerateHelpers(contents, name);

Invoke the reference API:

invokeReferenceAPI(contents, name, idFor,
dataSourceType.get(name),
retType);

If the developer decides that this method should return a feed, support should be added to return a feed.

writeJavaClass_FeedReturnHelpers(contents, idFor, name);
contents.append(“\r\n”);

If the developer decides that this method should return a response object, support should be added to return a response object.
writeJavaClass_AtomXmlReturnHelpers(contents, idFor, name, returnType);

If the developer decides that this method should return a jaxb-element<object>, support should be added for this return type.

writeJavaClass_JaxbAtomXmlReturnHelpers(contents, idFor, name,
returnType, objectName);

All exceptions provided in the reference API would then be processed.

writeJavaClass_Exceptions(mMth[i], contents);
contents.append(“ }\r\n”);
contents.append(“\r\n”);

If the developer decides that this method should return a feed, a createFeed Method is added that is specific to this method and its return type.

```
if (retType.equals(RetType.FEED)) {
  writeJayaClass_Feed(contents,
  mediaTypeProduces1.get(name),idFor, name);
}
```

Helper methods may be added to invoke reference API's etc.
writeJavaClass_AllHelpers(contents);

The contents of the class is written from string buffer to disk.
writeJavaClass_DumpSource(className, contents);

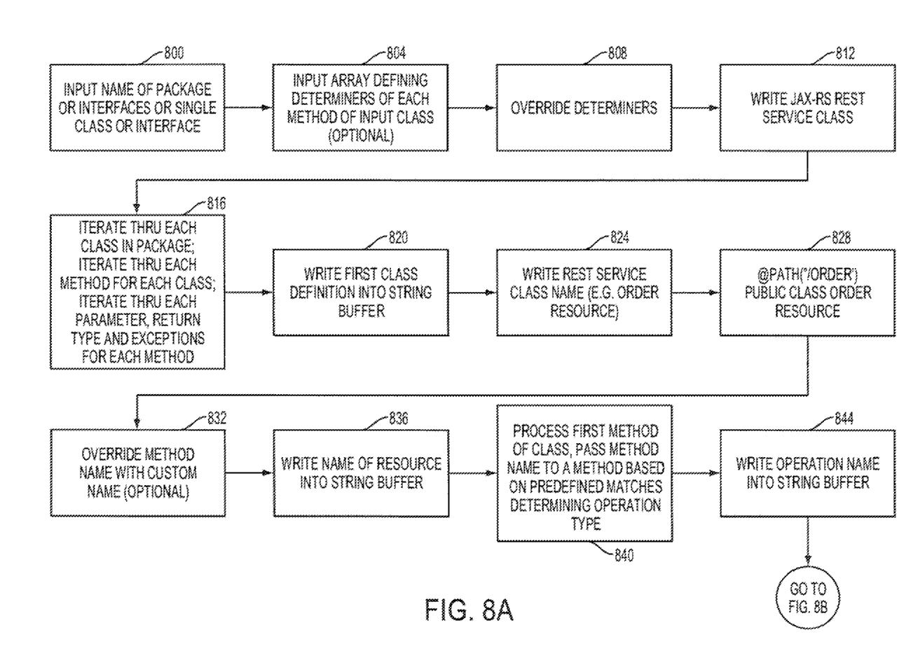

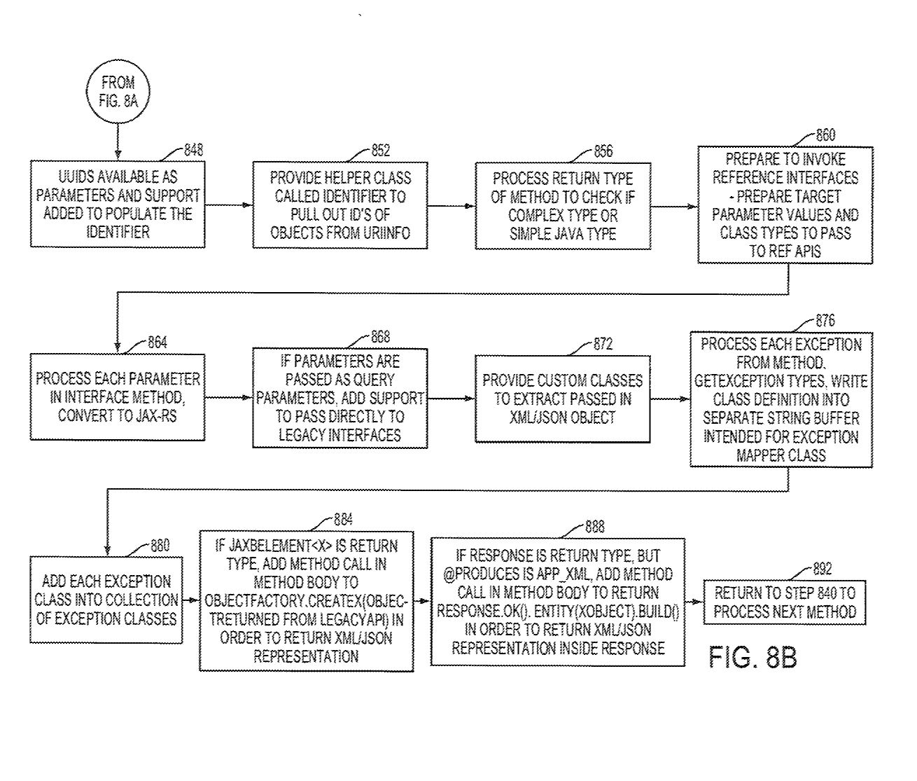

Referring now to FIGS. 8A-8B, the processing logic for auto generating JAX-RS services implementation classes in an exemplary embodiment is illustrated. The name of a package or reference interface could be input as indicated in step 800 to a REST server processor. In some instances, only a single class or interface is input. In step 804, an array which defines determiners could be inputted optionally. The determiners could include MIME, sub URI, and the HTTP operation of each method of the input class in case the default setting needs to be overridden. Determiners that were not given values in step 804 could be overridden with default values in step 808. The JAX-RS service class is now ready to be written as indicated in step 812. Each class in the specified package/reference interface could be processed as indicated in step 816. Each method could be determined for each class, and each parameter, return type, and all exceptions could be determined for each method. The determination of methods, parameters, return types, and exceptions required by step 816 could be performed by methods Class.getDeclaredMethods( ), method.getParameters( ), Method.getExceptionTypes( ), and method.getReturnTypes.

In step 820, the first class definition could be written into a string buffer. The entire Java class could be written into the string buffer, and at the end, the string buffer could be written to a storage device associated with the REST server computer system. As indicated in step 824, the name of the resource class is the current name appended by “Resource” so that the REST service class name could be written. Step 828 indicates that the processing logic could have written @Path(“/order) public class OrderResource. As an optional feature, the developer could override the method name with a custom name as indicated in step 832.

Next, in step 836, the name of the resource (e.g., getOrder) could be written into the string buffer (write getOrder). The developer could override the name with “order” for example. In step 840, the first method of the class is processed and the method name is passed into a method that determines the operation type based on some predefined matches. For example, getOrder has to be a @GET operation. In step 844, the operation name could be written into the string buffer.

In step 848, the UUIDs could be available to the developer as parameters and support could be added to populate the identifier (i.e., the actual order object for that UUID) from a class UUIDStore. The developer could use UUIDStore as a backend table or in a memory structure. In step 852, the developer could be provided with a helper class called Identifier which enables the developer to pull out the IDs of objects from UriInfo. In this case, the IDs are not available as parameters. Next, in step 856, in order to complete writing the first line of the first method, the return type of the method could be processed to determine whether the return type is a complex type or a simple Java type. If the reference interfaces need to be invoked and they form the data source of the method, in step 860 the processing logic could prepare to invoke the reference API, i.e., target parameter values and their class types could be prepared to be passed to reference APIs.

Every parameter in the interface method is processed as indicated in step 860. Each parameter in the interface method is converted to JAX-RS compatible parameters, taking special care of complex return types and arrays in step 864. If UUID is forced to be the first parameter, the processing logic could ignore the real first parameter as the UUID path parameter represents that ID. All simple Java types are QueryParams. If the parameters are passed as query parameters, support could be added, as indicated in step 868, to pass the query parameters directly to the legacy interfaces. In this case, no code to extract parameters from the feed would be added. In step 872, the developer could provide custom classes to extract the passed-in XML/JSON object. For example, this could be a jaxbelement <Object> or the same inside a feed. Supporting code guides the developer through this step.

In step 876, each exception from Method.getExceptionTypes could be processed. A class definition could be written into a separate string buffer for the exception mapper class. An if/else statement could be written for each type of exception for this method. This string buffer could be written to the disk when the whole package is processed. In step 880, each exception class could be added to a collection of exception classes so that the exceptions will not be added repeatedly. Next, as indicated in step 884, if jaxbelement<x> is the return type, a method call is added inside the method body to call ObjectFactory.createX(objectReturnedFromLegacyAPI) in order that the XML/JSON representation can be returned. If response is the return type, but @Produces is still APP_XML, as indicated in step 888, a method is added inside the method body to return Response.ok( ).entity(Xobject).build( ). This would enable the XML/JSON representation to be returned inside a response. Step 892 is a loop-back step that returns logic processing to step 840 to process the next method.

There are various URI formats to achieve the same thing, and that are equivalently mapped to the internal JAX-RS service implementation. For example, /order/1234 specifies the order with ID 1234, or alternately /order/getOrder?id=1234 to specify order 1234 could be used. Both are supported REST URI formats.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

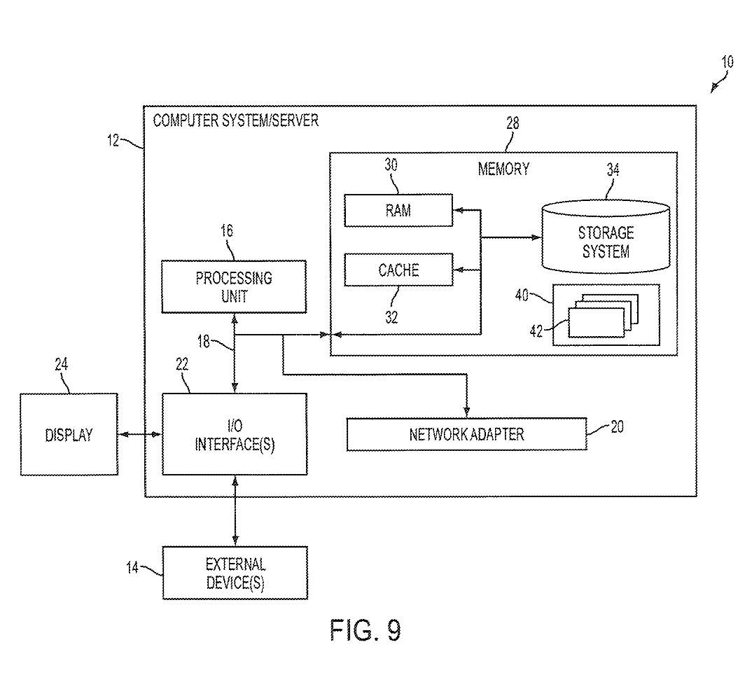

FIG. 9 illustrates a schematic of an exemplary computer system/server 12 for implementation of the REST server. Computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed computing environments that include any of the above systems or devices, and the like. Computer system/server 12 can represent a computer node 10 in a computer communications system.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 9, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media accessible by computer system/server 12, and includes both volatile and non-volatile media, removable and non-removable media,

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method for auto generating a Java interface (JAX-RS) for representational state transfer (REST) web services by a web server processing system, comprising:
receiving a reference interface for a REST service object;
receiving a set of determiners defining a plurality of configuration values for a REST service object to generate a service binding;
determining a plurality of resource methods for each resource class in the reference interface, and for each resource method, determining a parameter, a return type, and an exception;
sequentially processing each resource method of each class and writing the name of each resource into a string buffer;
determining the operation type for each resource method for each resource class based on at least one predefined match and writing an operation name into the string buffer for each resource method;
determining a return type for each resource method for each resource class; and
converting each parameter in the resource method to a JAX-RS compatible parameter.

2. The method for auto generating a Java interface of claim 1 further comprising writing a class definition into the string buffer, writing a Java class into the string buffer, and writing the string buffer onto a storage device.

3. The method for auto generating a Java interface of claim 1 further comprising providing a default value for any parameter not provided with a configuration value.

4. The method for auto generating a Java interface of claim 1 further comprising processing each exception and writing a class definition for an exception mapper to a second string buffer.

5. The method for auto generating a Java interface of claim 1 further comprising using universally unique identifiers (UUIDs) as parameters and automatically generating UUID support to populate an identifier from a UUID store in a memory.

6. The method for auto generating a Java interface of claim 5 further comprising automatically generating an exception mapper to handle exceptions for an associated resource method.

7. The method for auto generating a Java interface of claim 1 further comprising preparing a plurality of target parameter values and class types to be passed to the reference interface.

8. The method for auto generating a Java interface of claim 7 further comprising providing a query parameter for each resource method parameter.

9. The method for auto generating a Java interface of claim 1 further comprising automatically passing query parameters directly to a legacy interface.

10. The method for auto generating a Java interface of claim 1 further comprising providing a custom class to extract an Extensible Markup Language (XML) object or a JavaScript Object Notation (JSON) object.

11. The method for auto generating a Java interface of claim 1 further comprising adding each exception class to a collection of exception classes.

12. The method for auto generating a Java interface of claim 1 further comprising returning an Extensible Markup Language (XML) representation or a JavaScript Object Notation (JSON) representation.

13. A computer program product for auto generating a Java interface (JAX-RS) for representational state transfer (REST) web services when executed on a computer processor, the computer program product comprising a tangible computer readable medium having embedded thereon:
program instructions that cause the processor to receive a reference interface for a REST service object;
program instructions that cause the processor to receive a set of determiners defining a plurality of configuration values for a REST service object to generate a service binding;
program instructions that cause the processor to determine a plurality of resource methods for each resource class in the reference interface, and for each resource method, determine a parameter, a return type, and an exception;
program instructions that cause the processor to sequentially process each resource method of each resource class and to write the name of each resource into a string buffer;
program instructions that cause the processor to determine the operation type for each resource method for each resource class based on at least one predefined match and to write an operation name into the string buffer for each resource method;
program instructions that cause the processor to determine a return type for each resource method for each class; and
program instructions that cause the processor to convert each parameter in the resource method to a JAX-RS compatible parameter.

14. The computer program product for auto generating a Java interface of claim 13, the computer readable medium further comprising program instructions that cause the processor to write a class definition into the string buffer, to write a Java class into the string buffer, and to write the string buffer onto a storage device.

15. The computer program product for auto generating a Java interface of claim 13, the computer readable medium further comprising program instructions that cause the processor to provide a default value for any parameter not provided with a configuration value.

16. The computer program product for auto generating a Java interface of claim 13, the computer readable medium further comprising program instructions that cause the processor to process each exception and to write a class definition for an exception mapper to a second string buffer.

17. The computer program product for auto generating a Java interface of claim 13, the computer readable medium further comprising program instructions that cause the processor to use universally unique identifiers (UUIDs) as parameters and to automatically generate QUID support to populate an identifier from a QUID store in a memory.

18. The computer program product for auto generating a Java interface of claim 13, the computer readable medium further comprising program instructions that cause the processor to automatically generate an exception mapper to handle exceptions for an associated resource method.

19. The computer program product for auto generating a Java interface of claim 13, the computer readable medium further comprising program instructions that cause the processor to prepare a plurality of target parameter values and class types to be passed to the reference interface.

20. The computer program product for auto generating a Java interface of claim 13, the computer readable medium further comprising program instructions that cause the processor to provide a query parameter for each resource method parameter.

21. The computer program product for auto generating a Java interface of claim 13, the computer readable medium further comprising program instructions that cause the processor to automatically pass query parameters directly to a legacy interface.

22. The computer program product for auto generating a Java interface of claim 13, the computer readable medium further comprising program instructions that cause the processor to provide a custom class to extract an Extensible Markup Language (XML) object or a JavaScript Object Notation (JSON) object.

23. The computer program product for auto generating a Java interface of claim 13, the computer readable medium further comprising program instructions that cause the processor to return an Extensible Markup Language (XML) representation or a JavaScript Object Notation (JSON) representation.

24. A system for auto generating a Java interface (JAX-RS) for representational state transfer (REST) web services, comprising:
a web server for exposing a web service interface for implementation of JAX-RS for REST web services;
a processor for executing a plurality of modules, including:
a module for receiving a reference interface for a REST service object;
a module for receiving a set of determiners defining a plurality of configuration values for a REST service object to generate a service binding;
a module for determining a plurality of resource methods for each resource class in the reference interface, and for each resource method, determining a parameter, a return type, and an exception;
a module for sequentially processing each resource method of each class and writing the name of each resource into a string buffer;
a module for determining the operation type for each resource method for each resource class based on at least one predefined match and writing an operation name into the string buffer for each resource method;
a module for determining a return type for each resource method for each resource class; and
a module for converting each parameter in the resource method to a JAX-RS compatible parameter.

25. The system for auto generating a Java interface of claim 24 further comprising a storage device for storing a string buffer including a resource class definition and a Java class.
